(19) United States
(12) Patent Application Publication
(10) Pub. No.: US 2025/0187915 A1
(43) Pub. Date: Jun. 12, 2025

(54) DRY REFORMING OF METHANE USING A NICKEL-BASED BI-METALLIC CATALYST

(71) Applicant: Saudi Arabian Oil Company, Dhahran (SA)

(72) Inventors: Kunho Lee, Dhahran (SA); Sai P. Katikaneni, Dhahran (SA); Aadesh Harale, Dhahran (SA); Bandar Solami, Dhahran (SA)

(21) Appl. No.: 19/056,306

(22) Filed: Feb. 18, 2025

Related U.S. Application Data
(62) Division of application No. 17/401,071, filed on Aug. 12, 2021, now Pat. No. 12,258,272.

(51) Int. Cl. C01B 3/40; B01J 7/00; B01J 8/06; B01J 23/10; B01J 23/46; B01J 23/755; B01J 23/89; B01J 37/18

(52) U.S. Cl. CPC C01B 3/40; B01J 7/00; B01J 8/06; B01J 23/10; B01J 23/462; B01J 23/755; B01J 23/894; B01J 37/18; B01J 2208/06; C01B 2203/0238; C01B 2203/1058; C01B 2203/1064; C01B 2203/1082; C01B 2203/1241

(57) ABSTRACT

A method of dry reforming methane with CO₂ using a bi-metallic nickel and ruthenium-based catalyst. A dry reformer having the bimetallic catalyst as reforming catalyst, and a method of producing syngas with the dry reformer.

### CROSS-REFERENCE TO RELATED PATENT APPLICATIONS

This application is a divisional of U.S. patent application Ser. No. 17/401,071, filed Aug. 12, 2021, the contents of which are incorporated by reference herein.

### TECHNICAL FIELD

This disclosure relates to a process of dry reforming methane using a nickel-based bi-metallic catalyst.

### BACKGROUND

Carbon dioxide (CO₂) is the primary greenhouse gas emitted through human activities, and reducing CO₂ emissions is a major challenge. Carbon dioxide may be generated in various industrial and chemical plant facilities, and ways to convert carbon dioxide into useful substances is actively researched. Dry reforming of methane is a process that produces an industrially useful synthetic gas called syngas (a mixture of hydrogen and carbon monoxide) by reacting carbon dioxide with methane at high temperatures in the presence of a catalyst (CH₄+CO₂⇄2 H₂+2 CO, ΔH°₂₉₈=247.3 kJ/mol). The syngas produced by dry reforming can be used directly in the synthesis of various chemical substances or hydrocarbons, and thus is a valuable product. However, there are several obstacles hindering practical commercialization of this process, including the instability and low activity of catalysts typically used in the dry reforming process.

Because dry reforming of methane gives higher conversion rates as temperature increases, in order to obtain a high-purity product, the reaction is typically carried out at temperatures of about 600° C. or higher in the presence of a catalyst. However, when typical catalysts are exposed to such high temperatures for an extended period of time, the active metal of the catalyst is sintered, thereby reducing its active surface.

Another problem encountered in dry reforming is the solid-carbon formation in the dry-reformer reactor vessel, where the surface of the active metal of the catalyst is covered with carbon as a side reaction product. The solid carbon or carbonaceous material is called coke, and the solid-carbon formation is sometimes called coke formation. Deposition of the solid carbon on the reforming catalyst can reduce catalyst effectiveness and consequently lower conversion of the feed into syngas. Accordingly, the activity of catalysts used in the dry reforming process generally tends to decrease over time.

### SUMMARY

An aspect relates to a method of dry reforming methane, including reacting the methane with carbon dioxide via a reforming catalyst to generate synthesis gas including hydrogen and carbon monoxide, wherein the reforming catalyst includes a nickel component, a ruthenium component, a cerium oxide component, and a gadolinium oxide component.

Another aspect relates to a method of dry reforming methane, including providing methane and carbon dioxide to a dry reformer vessel, wherein a reforming catalyst including a nickel component, a ruthenium component, a cerium oxide component, and a gadolinium oxide component is disposed in the dry reformer vessel. The method includes dry reforming the methane in the dry reformer vessel via the reforming catalyst to generate hydrogen and carbon monoxide, and discharging the hydrogen and carbon monoxide from the dry reformer vessel.

Yet another aspect is a dry reformer including a dry reformer vessel having at least one inlet to receive methane and carbon dioxide. The dry reformer vessel has a reforming catalyst including a nickel component, a ruthenium component, a cerium oxide component, and a gadolinium oxide component to convert the methane and the carbon dioxide into syngas. The dry reformer vessel has an outlet to discharge the syngas, wherein the syngas includes hydrogen and carbon monoxide.

The details of one or more implementations are set forth in the accompanying drawings and the description below. Other features and advantages will be apparent from the description and drawings, and from the claims.

### BRIEF DESCRIPTION OF DRAWINGS

FIG. 1 is a thermodynamic equilibrium plot for the dry reforming of methane (CH₄:CO₂=1:1, 1 bar).

FIG. 2 is a thermodynamic equilibrium plot for solid carbon formation with increasing pressure (CH₄:CO₂=1:1).

FIG. 3 is a diagram of a dry reformer for dry reforming methane.

FIG. 4 is a block flow diagram of a method of dry reforming methane.

FIGS. 5A-5C, 6A-6C, 7A-7C, 8A-8C, and 9A-9C are plots of results of the Examples.

### DETAILED DESCRIPTION

Provided in the present disclosure is a method of dry reforming methane using a catalyst composition comprising a bi-metallic catalyst, such as a nickel and ruthenium-based catalyst. In some embodiments, the nickel and ruthenium-based catalyst is resistant to carbon formation, demonstrates high activity for dry reforming, and is resistant to sintering. In some embodiments of the method, the catalyst composition comprises a support. In some embodiments, the support has high oxygen vacancy.

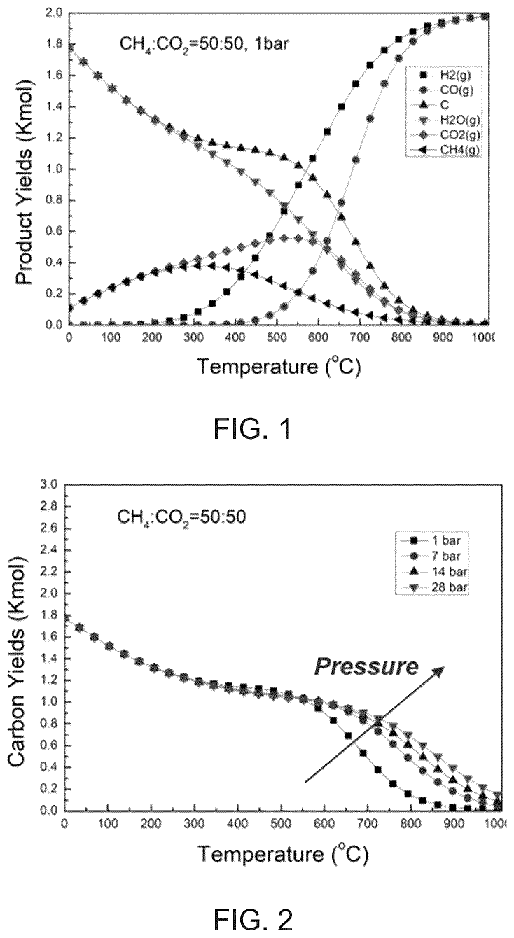

Carbon formation is thermodynamically favored under dry reforming conditions. To prevent carbon formation, high temperatures are normally required; however, at these high temperatures, metal catalysts are prone to be deactivated due to agglomeration or sintering with the support. FIG. 1 shows a thermodynamic equilibrium plot for dry reforming methane (CH₄:CO₂=1:1) at 1 bar while FIG. 2 is a plot showing the solid carbon formation trend with increasing pressure for a 1:1 mixture of CH₄:CO₂.

The method of the present disclosure provides a solution to the problem of increased greenhouse gases, including carbon dioxide and methane, by utilizing dry reforming to convert carbon dioxide and methane to synthesis gas, or “syngas” (a mixture of hydrogen (H₂) and carbon monoxide (CO)). Thus, the method of the present disclosure utilizes not just one, but two harmful greenhouse gases, CO₂ and methane, to produce syngas, an industrially useful gas. Syngas is a starting material building block in many industries, including oil and gas, and also is a suitable fuel for electricity generation in the power industry.

The catalyst composition used in the methods of the present disclosure comprises a nickel (Ni) component, a cerium (Ce) oxide component, a gadolinium (Gd) oxide component, and a ruthenium (Ru) component. The nickel component is an active metal of the catalyst. Addition of a small amount of ruthenium surprisingly has been found to improve the stability of the catalyst composition. While nickel is widely used for catalytic processes because it has high catalytic activity and is inexpensive, nickel is vulnerable to coke formation compared to precious metals such as rhodium, platinum and ruthenium. The cerium and gadolinium components (collectively “CGO” or “Gd-doped CeO₂”) function as the catalyst support. The CGO is effective to improve the tolerance of the catalyst composition to coke formation. Without wishing to be bound by any particular theory, it is believed that CGO suppresses coke formation on metals because CGO is an ionic conductive material. In some embodiments, the CGO has a high ionic conductivity. Thus, in some embodiments, the catalyst is resistant to the formation of coke on the catalyst during use of the catalyst.

Further, and without wishing to be bound by any particular theory, it is believed that when the reactants (CO₂ and CH₄) meet the catalyst, the CGO support, which has high oxygen vacancy, can improve the motility of the oxygen ion and provide the oxygen that likely helps to react with the carbon sources, as well as prevent dissociation of the CO. As a result, the particular combination of the bi-metallic catalyst and the CGO support improve the dry reforming reaction.

In some embodiments, the catalyst composition used in the methods of the present disclosure comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ. An exemplary catalyst is the catalyst disclosed in U.S. Pat. No. 9,181,148, which is incorporated by reference in its entirety herein.

Thus, in some embodiments, provided is a method of dry reforming methane using a catalyst comprising a nickel component, a cerium oxide component, a gadolinium oxide component, and a ruthenium component, where the catalyst is resistant to the formation of coke on the catalyst during use of the catalyst. In some embodiments of the method, the catalyst comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ.

Provided in the present disclosure is a method of dry reforming methane with CO₂ using a bi-metallic catalyst comprising a nickel component, a cerium oxide component, a gadolinium oxide component, and a ruthenium component, without the formation of carbon. In some embodiments of the method, the catalyst composition comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ.

Also provided in the present disclosure is a method of dry reforming methane with CO₂ using a bi-metallic catalyst comprising a nickel component, a cerium oxide component, a gadolinium oxide component, and a ruthenium component, without sintering the catalyst. In some embodiments of the method, the catalyst composition comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ.

Also provided is a method of dry reforming methane using a catalyst that is resistant to deactivation due to agglomeration or sintering with the support. Thus, the methods of the present disclosure utilize an efficient and durable catalyst that provides environmental and economic advantages, and overcomes several of the technical challenges that prevent commercialization of dry reforming. In some embodiments of the method, the catalyst composition comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ.

The methods of the present disclosure advantageously produce syngas using a dry reforming process of methane with CO₂ over an extended period of time without experiencing deactivation of the bi-metallic nickel and ruthenium-based catalyst described in the present disclosure. In some embodiments, the syngas is produced using a dry reforming process of methane with CO₂ without experiencing deactivation of the bi-metallic nickel and ruthenium-based catalyst over a period of time of about 8 hours. In some embodiments of the method, the dry reforming process operates under higher pressures than are typically used in dry reforming processes that do not utilize the bi-metallic nickel and ruthenium-based catalyst described in the present disclosure, such as higher than typical pressures of up to about 30 bar.

In some embodiments, provided is a method of dry reforming methane with CO₂ that results in increased conversion of reactants (methane and CO₂) as compared to dry reforming methods that do not use the bi-metallic nickel and ruthenium-based catalyst described in the present disclosure. Methane and CO₂ conversions are dependent on temperature and pressure. In some embodiments, methane conversions increase with increased temperature and achieve equilibrium conversions with active catalysts. In some embodiments, the bi-metallic catalyst achieves equilibrium conversion for both methane and CO₂ up to pressures of about 14 bar and temperatures up to about 700° C. In some embodiments, the dry reforming has a conversion for both methane and CO₂ of at least about 50%, at least about 60%, at least about 70%, or at least about 80% at pressures up to about 14 bar or greater and temperatures up to about 700° C. or higher.

In some embodiments, the bi-metallic catalyst is activated prior to use in the dry reforming process. In some embodiments, the catalyst is activated by reducing the catalyst with hydrogen (H₂) and nitrogen (N₂) at about 700-800° C. for about 3-6 hours, such that the catalyst is activated. In some embodiments, the hydrogen (H₂) is present in an amount up to about 30% wt and the remainder is nitrogen (N₂). For example, the amount of hydrogen present is about 1 wt % to about 30 wt %, about 5 wt % to about 30 wt %, about 10 wt % to about 30 wt %, about 15 wt % to about 30 wt %, about 20 wt % to about 30 wt %, about 25 wt % to about 30 wt %, about 1 wt % to about 25 wt %, about 5 wt % to about 25 wt %, about 10 wt % to about 25 wt %, about 15 wt % to about 25 wt %, about 20 wt % to about 25 wt %, about 1 wt % to about 20 wt %, about 5 wt % to about 20 wt %, about 10 wt % to about 20 wt %, about 15 wt % to about 20 wt %, about 1 wt % to about 15 wt %, about 5 wt % to about 15 wt %, about 10 wt % to about 15 wt %, about 1 wt % to about 10 wt %, about 5 wt % to about 10 wt %, or about 1 wt % to about 5 wt %, and the remainder is nitrogen. In some embodiments, the hydrogen is about 30% wt. In other embodiments, the nitrogen is about 70% wt. In some embodiments, pretreatment, or activation, of the catalyst compositions is necessary as nickel converts to a non-active form of nickel oxide during the preparation of the catalyst compositions.

The methods of the present disclosure produce H₂ and CO. In some embodiments, renewable hydrogen is introduced to the product. In some embodiments, addition of renewable hydrogen adjusts the ratio of H₂ to CO by increasing the amount of H₂. In some embodiments, this allows for application of the product directly to other downstream processes. In some embodiments, the downstream process is liquid hydrocarbon synthesis. In some embodiments, the downstream process is liquid hydrocarbon synthesis through the Fischer-Tropsch process.

The catalyst composition of the present disclosure can be prepared using a glycine nitrate process (“GNP”), such as disclosed in U.S. Pat. No. 9,181,148, and incorporated by reference in its entirety herein. In some embodiments, the process includes adding stoichiometric amounts of Ce(NO₃)₃.6H₂O, Gd(NO₃)₃.6H₂O, Ni(NO₃)₂.6H₂O, and Ru(NO)(NO₃)₃ to de-ionized water to create a dissolved solution. Glycine is added to the dissolved solution to create a glycine-dissolved solution. The glycine-dissolved solution is heated such that excess water is evaporated, combustion is initiated, and a catalyst powder is produced. The catalyst powder is calcined in air at 800° C. for 4 hours. The resulting powder after the combustion is calcinated in order to stabilize the active metal and form the phase of CGO (Ce_{0.9}Gd_{0.1}O₂₋ₓ). To effectively suppress coke formation, the phase of CGO should be formed during the calcination.

Glycine is used as a fuel for glycine nitrate process, and after the combustion, the glycine should be combusted. Therefore, the amount and purity of glycine are less important than other elements. However, in some embodiments, a 1:1.5 nitrate:glycine molar ratio is used for the process. In some embodiments a ≥99% purity glycine is used. In further embodiments, the molar ratio of glycine to NO₃ of the glycine-dissolved solution is about 1.4. In further embodiments, the molar ratio of glycine to NO₃ of the glycine-dissolved solution is about 1.6.

In some embodiments, the catalyst powder is shaped into a form for use in the dry reforming process of converting methane and CO₂ into H₂ and CO. In some embodiments, the form is catalyst pellets. A person of skill in the art will understand the various forms in to which the catalysts could be shaped, and will understand how to select the best form for a given reactor and process. In some embodiments, the catalyst powder is pelletized using a hydraulic press. A person of skill in the art will understand the various other methods that can be used to shape catalysts.

As referred to herein, dry reforming is a process that reacts CH₄ with CO₂ to produce synthesis gas (syngas) with the aid of a catalyst. Dry reforming can be beneficial for consuming the two greenhouse gases (CH₄ and CO₂) to produce syngas, which can include hydrogen (H₂) and carbon monoxide (CO). The dry reforming reaction can be characterized as CH₄+CO₂→2H₂+2CO. In the methods of the present disclosure, dry reforming is processed on a reforming catalyst comprising a nickel component, a ruthenium component, a cerium oxide component, and a gadolinium component.

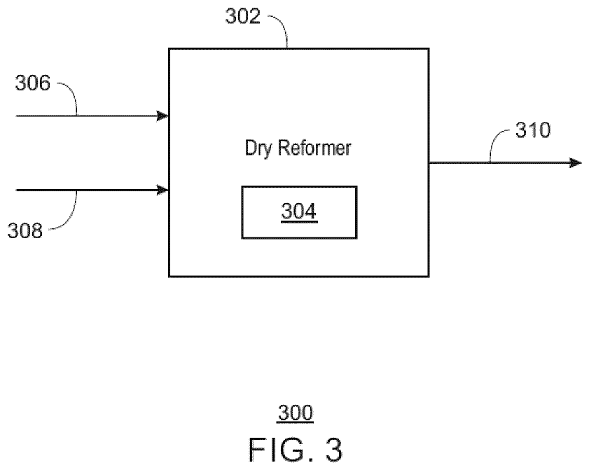

FIG. 3 is a dry reformer 300 (including a dry reformer vessel 302) to convert CH₄ in the presence of CO₂ and reforming catalyst 304 into syngas. The dry reformer 300 may be a dry reformer system. The dry reformer 300 or dry reformer vessel 302 may be characterized as a dry reformer reactor or dry reformer reactor vessel, respectively, for the dry reforming of methane to give syngas. A reforming catalyst 304 that is a bi-metallic nickel and ruthenium-based catalyst, as described in the present application, is disposed in the dry reformer vessel 302. The reforming catalyst 304 may be activated by reducing the catalyst with hydrogen (H₂) and nitrogen (N₂) at about 700-800° C. for about 3-6 hours, such that the catalyst is activated.

The dry reformer 300 may be, for instance, a fixed-bed reactor or a fluidized bed reactor. The dry reformer vessel 302 may be a fixed-bed reactor vessel having the reforming catalyst 304 in a fixed bed. In implementations, the fixed-bed reactor vessel may be a multi-tubular fixed-bed reactor. The dry reformer vessel 302 may be a fluidized-bed reactor vessel that operates with a fluidized bed of the reforming catalyst 304.

The operating temperature of the dry reformer 300 (the operating temperature in the dry reformer vessel 302) may be, for example, in the ranges of about 500° C. to about 1100° C., about 500° C. to about 1000° C., about 500° C. to about 900° C., at least about 500° C., less than about 1000° C., or less than about 900° C. The dry reforming reaction may generally be endothermic. The dry reformer vessel 302 (dry reformer reactor vessel) may have a jacket for heat transfer and temperature control. In operation, a heat transfer fluid (heating medium) may flow through the jacket for temperature control of the dry reformer 300 including the dry reformer vessel 302. Heat transfer may generally occur from the heat transfer fluid in the jacket to the dry reforming reaction mixture (process side of the dry reformer vessel 302). In other embodiments, electrical heaters may provide heat for the endothermic dry reforming reaction. The electrical heaters may be disposed in the dry reformer vessel 302 or on an external surface of the dry reformer vessel 302. In yet other embodiments, the dry reformer vessel 302 may be disposed in a furnace (for example, a direct fired heater) to receive heat from the furnace for the dry reforming reaction and for temperature control of the dry reformer 300. Other configurations of heat transfer and temperature control of the dry reformer 300 are applicable.

The operating pressure in the dry reformer vessel 302 may be, for example, in the range of about 1 bar to about 28 bar, or less than about 30 bar. In some embodiments, the operating pressure may be greater than about 30 bar to provide additional motive force for flow of the discharged syngas 310 to downstream processing. The downstream processing may include, for example, a Fischer-Tropsch (FT) system having a FT reactor vessel. The CO gas in the syngas 310 can be subjected to a water-gas shift reaction to obtain additional hydrogen.

In operation, the dry reformer vessel 302 may receive methane 306 and carbon dioxide 308. While the methane 306 and the carbon dioxide 308 are depicted as introduced separately into the dry reformer vessel 302, the methane 306 and carbon dioxide 308 may be introduced together as combined feed to the dry reformer vessel 302. The methane 306 stream may be or include natural gas. In other examples, the methane 306 stream includes CH₄ but is not a natural-gas stream. The methane 306 may be a process stream or waste stream having CH₄. The methane 306 stream may include CH₄, propane, butane, and hydrocarbons having a greater number of carbons. The methane 306 stream may include a mixture of hydrocarbons (e.g., C1 to C5), liquefied petroleum gas (LPG), and so on. Additional implementations of the methane 306 stream (for example, having CH₄) are applicable.

The dry reforming of the methane 306 via the CO₂ 308 and reforming catalyst 304 may give syngas 310 having H₂ and CO. The dry reforming reaction via the catalyst 304 in the dry reformer vessel 302 may be represented by CH₄+CO₂→2H₂+2CO. The molar ratio of H₂ to CO in the syngas 310 based on the ideal thermodynamic equilibrium is 1:1 but in practice can be different than 1:1. Unreacted CH₄ may discharge in the syngas 310 stream. In some implementations, unreacted CH₄ may be separated from the discharged syngas 310 and recycled to the dry reformer vessel 302. Moreover, the generated CO may be subjected to a water-gas shift reaction to obtain additional H₂, as given by CO+H₂O⇄CO₂+H₂. The water-gas shift reaction may be performed in the dry reformer vessel 302. The reforming catalyst 304 may promote the water-gas shift reaction if implemented. The water-gas shift reaction may instead be implemented downstream. The discharged syngas 310 may be processed to implement the water-gas shift reaction downstream of the dry reformer vessel 302. Utilization of the water-gas shift reaction, whether performed in the dry reformer vessel 302 or downstream of the dry reformer vessel 302, may be beneficial to increase the molar ratio of H₂/CO in the syngas 310 for downstream processing of the syngas 310. The downstream processing may include, for example, an FT reactor or other processing. In certain implementations, the molar ratio of H₂/CO may also be increased with the addition of supplemental H2 (e.g., from water electrolysis) to the discharged syngas 310.

The dry reformer 300 system includes feed conduits for the hydrocarbon 306 and the carbon dioxide 308, and a discharge conduit for the syngas 310. The dry reformer vessel 302 may be, for example, stainless steel. The dry reformer 302 vessel has one or more inlets to receive the feeds (e.g., 306, 308). The inlet(s) may be, for example, a nozzle having a flange or threaded (screwed) connection for coupling to a feed conduit conveying the feed to the dry reformer vessel 302. The vessel 302 may have an outlet (e.g., a nozzle with a flanged or screwed connection) for the discharge of produced syngas 310 through a discharge conduit for distribution or downstream processing. The flow rate (e.g., volumetric rate, mass rate, or molar rate) of the feed 306, 308 may be controlled via flow control valve(s) (disposed along respective supply conduits) or by a mechanical compressor, or a combination thereof. The ratio (e.g., molar, volumetric, or mass ratio) of the methane 306 to the carbon dioxide 308 may be adjusted by modulating (e.g., via one or more control valves) at least one of the flow rates of the methane 306 or the CO₂ 308. Lastly, the present dry reforming may be a technique for conversion of CH₄ and CO₂ into syngas without the introduction of oxygen (O₂) other than the less than about 1 wt % that might be present as a residual or contaminant in the feed 306. Thus, embodiments of the dry reforming do not include autothermal reforming (ATR). Further, embodiments of the dry reforming do not include steam reforming.

An embodiment is a dry reformer including a dry reformer vessel. The dry reformer vessel has at least one inlet to receive methane and CO₂. The dry reformer vessel has a reforming catalyst disposed in the vessel to convert the methane and CO₂ into syngas. The reforming catalyst includes or is a composition comprising a nickel component, a cerium oxide component, a gadolinium oxide component, and a ruthenium component, without sintering the catalyst. In some embodiments of the method, the catalyst composition comprises a nickel component present at about 19.5% wt., a cerium oxide component present at about 70% wt., a gadolinium oxide component present at about 10% wt., and a ruthenium component present at about 0.5% wt. In some embodiments, the catalyst composition comprises about 19.5 wt % Ni, about 0.5 wt % Ru, and about 80 wt % Ce_{0.9}Gd_{0.1}O₂₋ₓ. The dry reformer vessel has an outlet to discharge the syngas, wherein the syngas includes H₂ and CO. The dry reformer vessel may be a fixed-bed reactor vessel having the reforming catalyst in a fixed bed. If so, the fixed-bed reactor vessel may be a multi-tubular fixed-bed reactor. The dry reformer vessel may be a fluidized-bed reactor vessel to operate with a fluidized bed of the reforming catalyst.

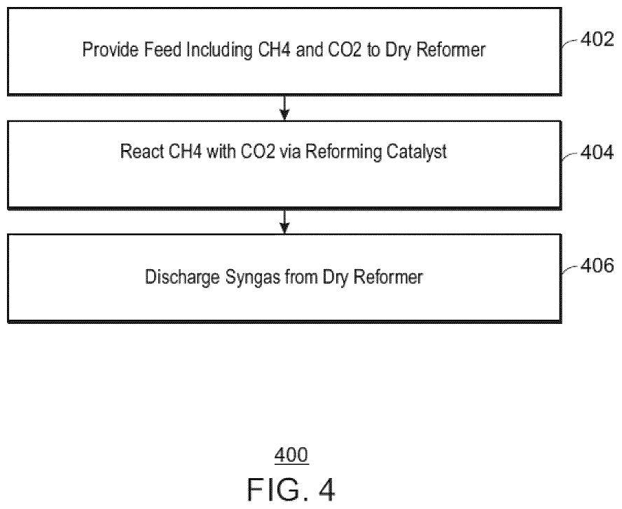

FIG. 4 is a method 400 of dry reforming methane. The methane feed can be or include natural gas. The methane feed may be a process stream or waste stream having CH₄. The methane feed may include CH₄, propane, butane, and hydrocarbons having a greater number of carbons.

At block 402, the method includes providing the methane feed and CO₂ to a dry reformer (e.g., to a dry reformer vessel). Reforming catalyst that is or includes a catalyst composition comprising a nickel component, a cerium oxide component, a gadolinium oxide component, and a ruthenium component is disposed in the dry reformer vessel. The catalyst composition may be the bi-metallic nickel and ruthenium-based catalyst composition as described in the present disclosure. The reforming catalyst may be a catalyst composition comprising a nickel component present at about 19.5% wt., a cerium oxide component present at about 70% wt., a gadolinium oxide component present at about 10% wt., and a ruthenium component present at about 0.5% wt. The reforming catalyst may be a catalyst composition that comprises about 19.5 wt % Ni, about 0.5 wt % Ru, and about 80 wt % Ce_{0.9}Gd_{0.1}O₂₋ₓ.

At block 404, the method include dry reforming the methane in the dry reformer via the reforming catalyst to generate H₂ and CO. The dry reforming involves reacting the methane with the CO₂ via the reforming catalyst. The method may include providing heat to the dry reformer (e.g., to the dry reformer vessel) for the dry reforming, wherein the reacting of the methane with the CO₂ is endothermic. Heat may be provided by external electrical heaters residing on the surface of the dry reformer vessel. Heat may be provided by disposing the dry reformer vessel in a furnace. Other techniques for providing heat to the dry reformer are applicable.

At block 406, the method includes discharging the H₂ and CO from the dry reformer (e.g., from the dry reformer vessel). The discharged stream having the H₂ and CO may be labeled as syngas. The syngas may be sent to transportation or distribution. The syngas may be sent to downstream processing. In some embodiments, supplemental H₂ may added to the syngas to increase the molar ratio of H₂ to CO in the syngas. In certain embodiments, the water-gas shift reaction may be implemented in the dry reformer vessel or downstream of the dry reformer vessel to generate additional H₂ to increase the molar ratio of H₂ to CO in the syngas.

An embodiment is a method of dry reforming methane. The method includes reacting the method with CO₂ via a reforming catalyst to generate syngas including H₂ and CO. The reforming catalyst is or includes a catalyst composition comprising a nickel component, a cerium oxide component, a gadolinium oxide component, and a ruthenium component is disposed in the dry reformer vessel. The catalyst composition may be the bi-metallic nickel and ruthenium-based catalyst composition as described in the present disclosure. The reforming catalyst may be a catalyst composition comprising a nickel component present at about 19.5% wt., a cerium oxide component present at about 70% wt., a gadolinium oxide component present at about 10% wt., and a ruthenium component present at about 0.5% wt. The reforming catalyst may be a catalyst composition that comprises about 19.5 wt % Ni, about 0.5 wt % Ru, and about 80 wt % Ce_{0.9}Gd_{0.1}O₂₋ₓ.

The term “about” as used herein can allow for a degree of variability in a value or range, for example, within 10%, within 5%, or within 1% of a stated value or of a stated limit of a range.

### EXAMPLES

The nickel and ruthenium based catalyst of the present disclosure is prepared according to the method described in U.S. Pat. No. 9,181,148, incorporated by reference in its entirety herein. For example, the Nickel/Ruthenium/CGO catalysts are prepared by adding Ce(NO₃)₃.6H₂O, Gd(NO₃)₃.6H₂O, Ni(NO₃)₂.6H₂O, and Ru(NO)(NO₃)₃ to de-ionized water to create a dissolved solution. The amount of each nitrate is stoichiometrically calculated. For example, to make 19.5% Ni-0.5% Ru/CGO catalyst, the molar ratio of the four components is Ce(NO₃)₃.6H₂O:Gd(NO₃)₃.6H₂O:Ni(NO₃)₂.6H₂O:Ru(NO)(NO₃)₃=0.9:0.1:0.7218:0.01075. Glycine is added to the dissolved solution to create a glycine-dissolved solution. A 1:1.5 nitrate: glycine molar ratio is used. The glycine-dissolved solution is heated about 2 hours to vaporize excess water, and spontaneous combustion begins at approximately 180° C. During the combustion, the internal temperature may suddenly to above 1000° C. The combustion is completed in a few minutes and the catalyst power is produced. The catalyst powder is shaped into a pellet and then calcined in air, increasing the temperature to 800° C. over a period of about 4hours, then maintaining the temperature at about 800° C. for 4 hours. After the calcination, calcined catalyst was ground uniformly with mortar and then shaped again into the pellet. The catalyst particles having 250 to 500 μm particle size are selected with sieves.

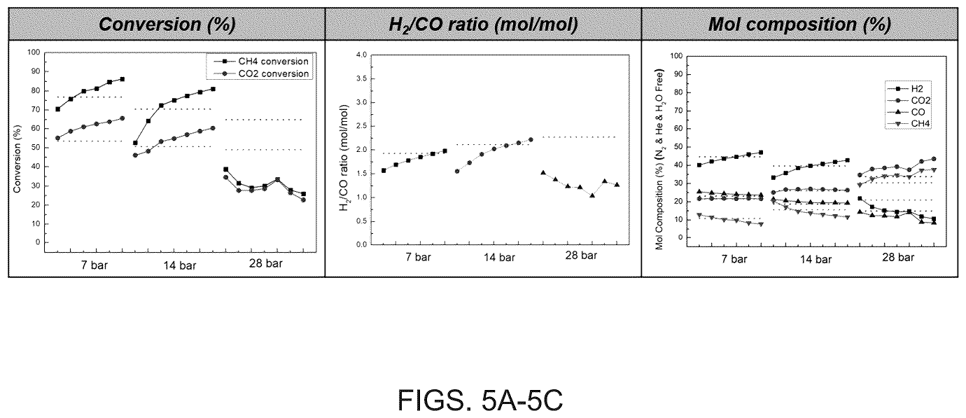

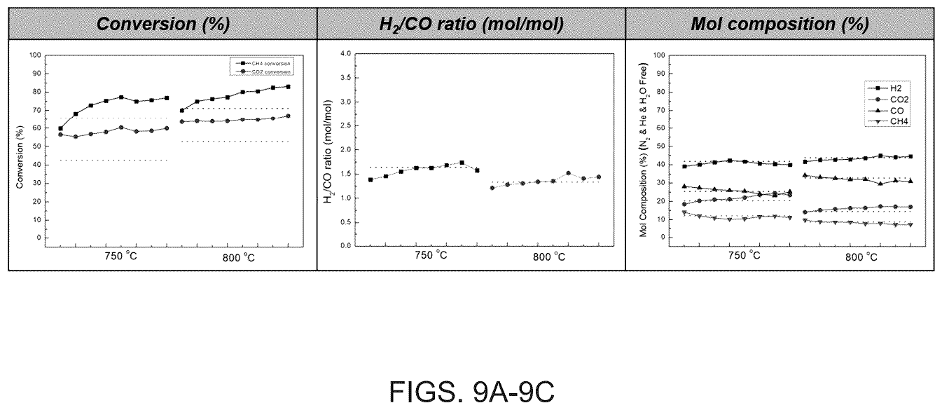

Various tests of dry reforming CH₄ with CO₂ were performed in a micro-reactor in the laboratory. The micro-reactor was a stainless-steel tube having a nominal diameter of 2 millimeters (mm). The micro-reactor was mounted in a furnace. The dry-reforming tests with the micro-reactor were carried out at various temperatures and pressures for 24 hours. The catalyst in the micro-reactor was the catalyst composition comprising 19.5 wt % Ni, 0.5 wt % Ru, and 80 wt % Ce_{0.9}Gd_{0.1}O₂₋ₓ. Approximately 50 milligrams (mg) of the catalyst was added to the micro-reactor. The test included introducing a feed of CH₄, CO₂, nitrogen (N₂), and helium (He) to the micro-reactor by a mass flow controller for the 24 hours. The ratio CH₄:CO₂:N₂:H₂ of the feed in volume percent was 30:31:31:8 (FIG. 5-7) or 16:48:32:4 (FIG. 9). The gas hour space velocity (GHSV) through the catalyst was 1500 h⁻¹. The temperature of micro-reactor was increased up to the target temperature at a ramp of 10° C. per minute and was maintained during the reaction. Online gas chromatography was employed to determine composition of the effluent gas discharged from the micro-reactor. Composition of effluent gas was analyzed with online gas chromatography in order to calculate conversions and the H₂/CO ratio. In one test (FIGS. 9A-9C), water was added to the feed mixture to increase the amount of H₂/CO ratio.

A dry reforming reaction as described above was performed at 700° C. and 7 bar, 14, or 28 bar, for 24 hours. The volume percent of CH₄ and CO₂ in the feed (on a nitrogen-free and helium-free basis) was 50:50. The catalyst composition was pre-treated prior to the dry reforming reaction by heating at 700° C. for 3 hours. FIG. 5A is a plot of CH₄ and CO₂ conversion (%) over time (hours) at 7 bar, 14 bar, or 28 bar at 700° C. FIG. 5B is a plot of the H₂/CO ratio (mol/mol) over time (hours) at 7 bar, 14 bar, or 28 bar at 700° C. FIG. 5C is a plot of mol composition (%) of the reactants and products over time (hours) at 7 bar, 14 bar, or 28 bar at 700° C. The thermodynamic equilibrium is shown as a dotted line in each plot. The results at each pressure tested are shown in Table 1.

TABLE 1

| | 7 bar | 14 bar | 28 bar |
|---|---|---|---|
| Ave. CH₄ conversion (%) | 79.7 | 71.8 | 30.8 |
| Ave. CO₂ conversion (%) | 61.1 | 54.1 | 28.7 |
| Ave. H₂/CO ratio (mol/mol) | 1.8 | 2.0 | 1.3 |
| Ave. H₂ (mol %) | 45.9 | 40.9 | 16.7 |
| Ave. CO₂ (mol % | 18.9 | 23.8 | 35.7 |
| Ave. CO (mol %) | 25.5 | 21.0 | 13.0 |
| Ave. CH₄ (mol %) | 9.7 | 14.2 | 34.7 |

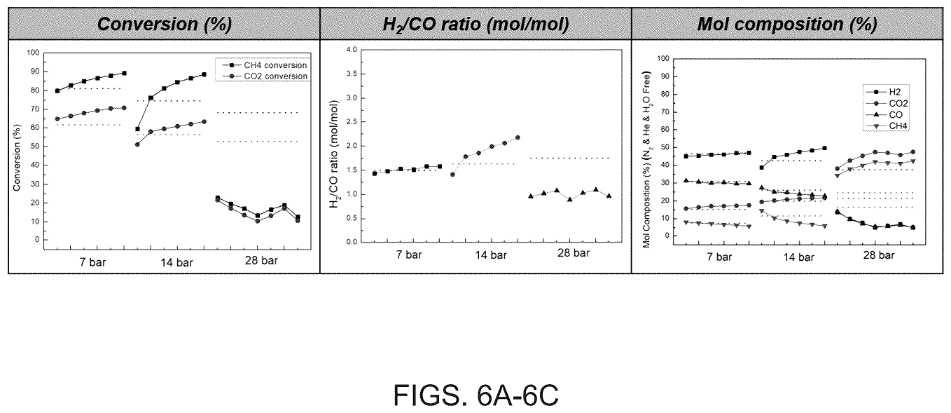

A dry reforming reaction as described above was performed at 750° C. and 7 bar, 14, or 28 bar, for 24 hours. The volume percent of CH₄ and CO₂ in the feed (on a nitrogen-free and helium-free basis) was 50:50. The catalyst composition was pre-treated prior to the dry reforming reaction by heating at 750° C. for 3 hours. FIG. 6A is a plot of CH₄ and CO₂ conversion (%) over time (hours) at 7 bar, 14 bar, or 28 bar at 750° C. FIG. 6B is a plot of the H₂/CO ratio (mol/mol) over time (hours) at 7 bar, 14 bar, or 28 bar at 750° C. FIG. 6C is a plot of mol composition (%) of the reactants and products over time (hours) at 7 bar, 14 bar, or 28 bar at 750° C. The thermodynamic equilibrium is shown as a dotted line in each plot. The results at each pressure tested are shown in Table 2.

TABLE 2

| | 7 bar | 14 bar | 28 bar |
|---|---|---|---|
| Ave. CH₄ conversion (%) | 85.1 | 79.2 | 16.1 |
| Ave. CO₂ conversion (%) | 67.0 | 57.6 | 17.2 |
| Ave. H₂/CO ratio (mol/mol) | 1.5 | 1.9 | 1.0 |
| Ave. H₂ (mol %) | 46.0 | 45.8 | 7.7 |
| Ave. CO₂ (mol % | 16.8 | 20.8 | 44.8 |
| Ave. CO (mol %) | 30.2 | 24.5 | 7.7 |
| Ave. CH₄ (mol %) | 6.9 | 9.0 | 39.8 |

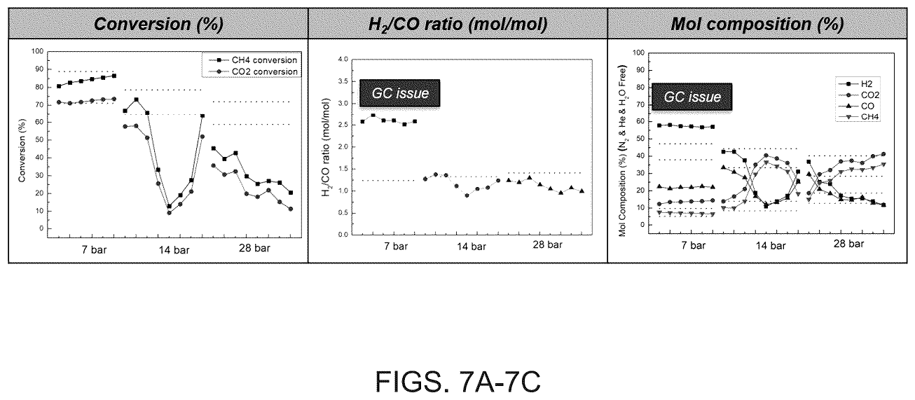

A dry reforming reaction as described above was performed at 800° C. and 7 bar, 14, or 28 bar, for 24 hours. The volume percent of CH₄ and CO₂ in the feed (on a nitrogen-free and helium-free basis) was 50:50. The catalyst composition was pre-treated prior to the dry reforming reaction by heating at 800° C. for 3 hours. FIG. 7A is a plot of CH₄ and CO₂ conversion (%) over time (hours) at 7 bar, 14 bar, or 28 bar at 800° C. FIG. 7B is a plot of the H₂/CO ratio (mol/mol) over time (hours) at 7 bar, 14 bar, or 28 bar at 800° C. FIG. 7C is a plot of mol composition (%) of the reactants and products over time (hours) at 7 bar, 14 bar, or 28 bar at 800° C. The thermodynamic equilibrium is shown as a dotted line in each plot. The results at each pressure tested are shown in Table 3.

TABLE 3

| | 7 bar | 14 bar | 28 bar |
|---|---|---|---|
| Ave. CH₄ conversion (%) | 84.5 | 46.01 | 26.7 |
| Ave. CO₂ conversion (%) | 71.3 | 34.9 | 24.9 |
| Ave. H₂/CO ratio (mol/mol) | 2.6 | 1.2 | 1.1 |
| Ave. H₂ (mol %) | 57.4 | 26.8 | 19.9 |
| Ave. CO₂ (mol % | 13.6 | 28.4 | 34.0 |
| Ave. CO (mol %) | 22.0 | 21.8 | 17.4 |
| Ave. CH₄ (mol %) | 7.1 | 23.0 | 28.7 |

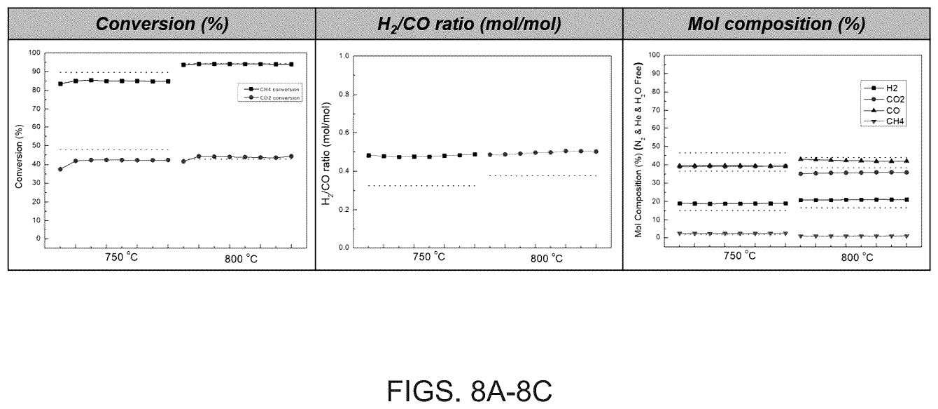

A dry reforming reaction as described above was performed at 750° C. and 14 bar for 24 hours or 800° C. and 14 bar for 24 hours. The volume percent of CH₄ and CO₂ in the feed (on a nitrogen-free and helium-free basis) was 25:75. The catalyst composition was pre-treated prior to the dry reforming reaction by heating at 800° C. for 6 hours at 14 bar. FIG. 8A is a plot of CH₄ and CO₂ conversion (%) over time (hours) at 14 bar at 750° C. and 800° C. FIG. 8B is a plot of the H₂/CO ratio (mol/mol) over time (hours) at 14 bar at 750° C. and 800° C. FIG. 8C is a plot of mol composition (%) of the reactants and products over time (hours) at 14 bar at 750° C. and 800° C. The thermodynamic equilibrium is shown as a dotted line in each plot. The results at each temperature tested are shown in Table 4.

TABLE 4

| | 750° C. | 800° C. |
|---|---|---|
| Ave. CH₄ conversion (%) | 84.9 | 94.1 |
| Ave. CO₂ conversion (%) | 41.7 | 43.8 |
| Ave. H₂/CO ratio (mol/mol) | 0.5 | 0.5 |
| Ave. H₂ (mol %) | 19.0 | 21.0 |
| Ave. CO₂ (mol % | 39.2 | 35.7 |
| Ave. CO (mol %) | 39.5 | 42.4 |
| Ave. CH₄ (mol %) | 2.4 | 0.9 |

A dry reforming reaction as described above was performed at 750° C. and 14 bar for 24hours or 800° C. and 14 bar for 24 hours. The volume percent of CH₄, CO₂, and water in the feed (on a nitrogen-free and helium-free basis) was 40:40:20. The catalyst composition was pre-treated prior to the dry reforming reaction by heating at 800° C. for 6 hours at 14 bar. FIG. 9A is a plot of CH₄ and CO₂ conversion (%) over time (hours) at 14 bar at 750° C. and 800° C. FIG. 9B is a plot of the H₂/CO ratio (mol/mol) over time (hours) at 14 bar at 750° C. and 800° C. FIG. 9C is a plot of mol composition (%) of the reactants and products over time (hours) at 14 bar at 750° C. and 800° C. The thermodynamic equilibrium is shown as a dotted line in each plot. The results at each temperature tested are shown in Table 5.

TABLE 5

| | 750° C. | 800° C. |
|---|---|---|
| Ave. CH₄ conversion (%) | 72.7 | 78.1 |
| Ave. CO₂ conversion (%) | 58.1 | 64.7 |
| Ave. H₂/CO ratio (mol/mol) | 1.6 | 1.36 |
| Ave. H₂ (mol %) | 40.8 | 43.5 |
| Ave. CO₂ (mol % | 21.8 | 16.2 |
| Ave. CO (mol %) | 25.8 | 32.0 |
| Ave. CH₄ (mol %) | 11.6 | 8.3 |

As can be seen by the results described in the Examples and shown in FIGS. 5-9, the catalyst gave good conversions of CH₄ and CO₂ at the dry-reforming pressures tested, particularly at 7 bar and 14 bar, and at the various temperatures tested. The catalyst showed strong performance at pressures up to about 14 bar and in the 700° C.-900° C. temperature range.

A number of embodiments have been described. Nevertheless, it will be understood that various modifications may be made without departing from the spirit and scope of the disclosure.

What is claimed is:

1. A dry reformer comprising:
a dry reformer vessel comprising:
at least one inlet to receive methane and carbon dioxide;
a reforming catalyst comprising a nickel component, a ruthenium component, a cerium oxide component, and a gadolinium oxide component to convert the methane and the carbon dioxide into syngas; and
an outlet to discharge the syngas, wherein the syngas comprises hydrogen and carbon monoxide.

2. The dry reformer of claim 1, wherein the dry reformer vessel comprises a fixed-bed reactor vessel comprising the reforming catalyst in a fixed bed.

3. The dry reformer of claim 2, wherein the fixed-bed reactor vessel comprises a multi-tubular fixed-bed reactor.

4. The dry reformer of claim 1, wherein the dry reformer vessel comprises a fluidized-bed reactor vessel to operate with a fluidized bed of the reforming catalyst.

5. The dry reformer of claim 1, wherein the reforming catalyst comprising the calcined black powder comprises about 19.5 wt % of a nickel component; about 0.5 wt % of a ruthenium component; about 70 wt % of a cerium oxide component; and about 10% of a gadolinium oxide component.

6. The dry reformer of claim 1, wherein the cerium and gadolinium oxide component is Ce_{0.9}Gd_{0.1}O₂₋ₓ.

7. The dry reformer of claim 1, wherein the catalyst comprises 19.5 wt % of a nickel component; 0.5 wt % of a ruthenium component; and 80 wt % of Ce_{0.9}Gd_{0.1}O₂₋ₓ.

8. The dry reformer of claim 1, wherein the catalyst is resistant to the formation of coke on the catalyst during use of the catalyst.

9. The dry reformer of claim 1, wherein a molar ratio of the hydrogen and carbon monoxide present in the synthesis gas is 1.8:1 to 1.9:1.

10. The dry reformer of claim 1, wherein a molar ratio of the hydrogen and carbon monoxide present in the synthesis gas is 1.5:1 to 1:2.
